(19) United States
(12) Patent Application Publication
(10) Pub. No.: US 2012/0262450 A1
(43) Pub. Date: Oct. 18, 2012

(54) IMAGE DISPLAY APPARATUS AND IMAGE DISPLAY METHOD

(75) Inventor: Toshitaka Aiba, Tokyo (JP)

(73) Assignee: CANON KABUSHIKI KAISHA, Tokyo (JP)

(21) Appl. No.: 13/442,604

(22) Filed: Apr. 9, 2012

(30) Foreign Application Priority Data
Apr. 12, 2011 (JP) 2011-088461

(51) Int. Cl. G06T 15/00

(52) U.S. Cl. 345/419

(57) ABSTRACT

An image display apparatus according to the present invention can display an image optimally even if a 3D image and a 2D image are mixed after rotational editing. The image display apparatus displays a 3D image by performing image processing corresponding to rotation information, determines whether rotation information exists, and determines whether an image is rotated from a state of an angle at which stereoscopic display is performed if the rotation information exists. The image display apparatus performs a stereoscopic display on a display area using a plurality of images if the image is not rotated and displays any one of the plurality of images if the image is rotated. When the 3D image is changed into the 2D image by processing for rotating the 3D image, the image display apparatus stores information for returning the 2D image into the original 3D image.

### BACKGROUND OF THE INVENTION

1. Field of the Invention

The present invention relates to an image display apparatus and an image display method and, in particular, to a technique suitable for use in a case where a three-dimensional (3D) image is mixed with a two-dimensional (2D) image after rotation editing is performed.

2. Description of the Related Art

A method for forming a 3D image from two photographs has been known since a long time ago. In recent years, a 3D image format for digital cameras has been put into practical use and digital cameras capable of capturing 3D images have appeared. Image browsers for browsing 3D images have also appeared. In such a situation, Japanese Patent Application Laid-Open No. 2005-159755 discusses an image editing apparatus capable of easily rotating and editing 3D images has appeared.

In the image editing apparatus discussed in Japanese Patent Application Laid-Open No. 2005-159755, editing is performed with a stereoscopically viewable state maintained in editing for rotating 3D images, so that a rotatable angle is limited to 180 degrees.

In general, in order to perform the rotation except 180 degrees, a 3D image is separated into a left-eye image and a right-eye image, and any one of the images is rotated. For this reason, a problem is caused in that a 2D image instead of a 3D image is produced after the rotation.

Further, another problem is caused in that the rotation of the 3D image changes the 3D image to any of the 3D image or the 2D image depending on the angle of the rotation. Therefore, an appropriate image display method for a case where the 3D image and the 2D image are mixed has been demanded.

### SUMMARY OF THE INVENTION

The present invention is directed to an image display apparatus and an image display method capable of displaying an image optimally after rotational editing even if the 3D image and the 2D image are mixed.

According to an aspect of the present invention, an image display apparatus for displaying an image by performing image processing corresponding to rotation information includes a presence/absence determining unit configured to determine whether rotation information exists, a state determination unit configured to determine whether an image is rotated from a state of an angle at which stereoscopic display is performed if the rotation information exists, a display unit configured to perform a stereoscopic display on a display area using a plurality of images if the image is not rotated and display any one of the plurality of images if the image is rotated, and a control unit configured to control the operation of each unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example display of a thumbnail list according to an exemplary embodiment of the present invention.

FIG. 2 is a block diagram illustrating an example configuration of a 3D image display apparatus according to an exemplary embodiment of the present invention.

FIG. 3 illustrates a data structure of a multi-picture (MP) file according to a first exemplary embodiment.

FIG. 4 is a flow chart for determining processing for setting an MP status.

FIG. 5 is a flow chart for switching display processing of an image according to the MP status.

FIGS. 6A and 6B illustrate screens for displaying a 3D image and a 2D image in which the 3D image is rotated, respectively.

FIG. 7 is a flow chart illustrating processing performed after arbitrary rotation angle is input.

FIG. 8 is a flow chart for returning the 3D image subjected to rotation editing to a 3D image which can be stereoscopically viewed.

FIG. 9 illustrates a data structure of a multi-picture file according to a second exemplary embodiment.

FIGS. 10A and 10B illustrate screens for displaying a 3D image and a 2D image in which the 3D image is rotated, respectively.

FIG. 11 is a flow chart for determining processing for setting the MP status.

FIG. 12 is a flow chart illustrating processing for switching a 3D flag.

FIG. 13 illustrates a data structure of a multi-picture file according to a third exemplary embodiment.

FIG. 14 is a flow chart for determining processing for setting the MP status.

FIG. 15 is a flow chart illustrating processing for rotating an image.

FIG. 16 is a flowchart for returning a 3D image subjected to rotation editing to a 3D image which can be stereoscopically viewed.

### DESCRIPTION OF THE EMBODIMENTS

Various exemplary embodiments, features, and aspects of the invention will be described in detail below with reference to the drawings.

An image to be handled in the present exemplary embodiment is described below. A 3D image refers to an image which is stereoscopically viewed using two images with parallax. A 2D image in which the 3D image is rotated refers to an image represented as the 2D by rotation editing. The 2D image is the one that is not stereoscopically viewed.

In the present exemplary embodiment, an operation example in which the rotation editing of a stereoscopically viewable 3D image is performed and an image rotated as a non-stereoscopic normal image is displayed, and an operation example in which the rotation editing is returned to an original state, are described. An operation that the rotation editing is returned to an original state refers to the one that brings about a state of an angle (normal position) at which rotation information is stereoscopically displayed.

In the rotation processing of an image in the present exemplary embodiment, both images of the left- and right-eye images are rotated. It is presumed that an image in which the 3D image is rotated to be the 2D image always displays the left-eye image.

The 3D image discussed in the present exemplary embodiment is a multi-picture file captured by a camera capable of forming a stereoscopically displayable 3D image by one-time image-capturing.

The multi-picture file refers to a file in a multi-picture format in which a plurality of images is put in one file. The multi-picture file of the produced 3D image can be produced by one-time image-capturing, so that neither the left-eye image nor the right-eye image is rotated. For this reason, even if rotation angle information is not set to the multi-picture file, a rotation angle may be regarded as being set to 0 degree.

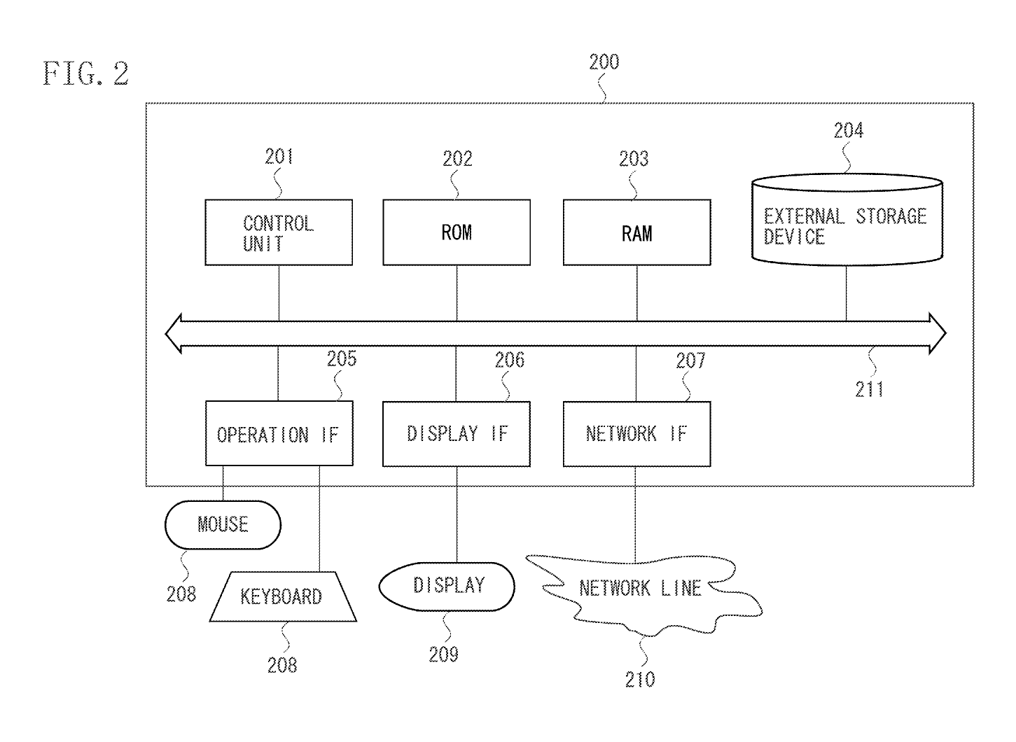

A 3D image display apparatus according to the present exemplary embodiment is realized by an application running on a personal computer (PC). FIG. 2 is a block diagram illustrating an example configuration of the 3D image display apparatus according to an exemplary embodiment of the present invention.

In FIG. 2, a control unit 201 controls the entire computer apparatus 200. The control unit 201 includes a central processing unit (CPU), for example. A read only memory (ROM) 202 stores a program and a parameter which do not need changing. A random access memory (RAM) 203 temporarily stores a program and data supplied from an external device.

An external storage device 204 includes a hard disk or a memory card which is stationarily mounted on the computer apparatus 200, a flexible disk (FD) and an optical disk such as a compact disk (CD) attachable to and detachable from the computer apparatus 200, a magnetic or an optical card, and an integrated circuit (IC) card.

An interface 205 is an interface with an input device 208 such as a pointing device and a keyboard by which user's operation is received to input data. An interface 206 is an interface with a display 209 for displaying data stored in the computer apparatus 200 and supplied data.

A network interface 207 connects with a network line such as the Internet 210. A system bus 211 communicably connects the units including the control unit 201 to the network interface 207 with one another.

The external storage device 204 stores a 3D image display program described later as a program code which can be read by the control unit 201. The program code is executed by the control unit 201. The 3D image display program in the external storage device 204 is composed of a first to a third step described below in an image processing method corresponding to the rotation information.

The first step is a presence or absence determination step of determining the presence or absence of rotation information. The second step is a state determination step of determining whether an image is rotated from a state of an angle at which stereoscopic display is performed if the rotation information exists. The third step is a display step of displaying any one of rotated images if the images are rotated or of performing stereoscopic display using two images if the images are not rotated.

An example operation of the 3D image display apparatus thus configured is described below.

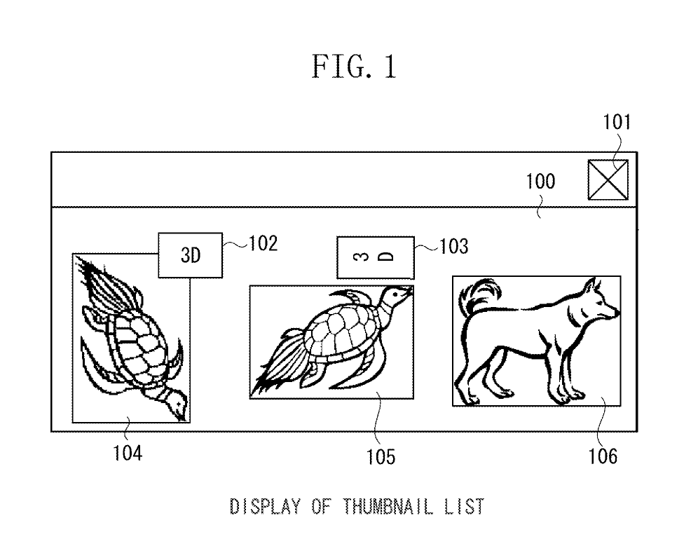

The 3D image display program is started to display a screen illustrated in FIG. 1 on the screen of the display 209 illustrated in FIG. 2. FIG. 1 illustrates the display of thumbnails of images stored in the external storage device 204 in FIG. 2.

In FIG. 1, in an area 100, image thumbnails and icons indicating the type of an image, are displayed. The screen includes an end button 100 used to end a program. An icon 102 indicates that an image can be three dimensionally (3D) displayed. An icon 103 indicates that the 3D image is two dimensionally (2D) displayed by the rotation processing.

The screen further includes a thumbnail 104 of an image. From the icon 102, it can be seen that the thumbnail 104 is the 3D image. The screen further includes a thumbnail 105 of an image. From the icon 103, it can be seen that the 3D image is subjected to the rotation processing to be 2D displayed.

The screen also includes a thumbnail 106 of an image. Because of absence of the icons 102 and 103, it can be seen that the image corresponding to the thumbnail 106 is the 2D image independent of the 3D image. A method for determining the absence of the icons 102 and 103 and the icon of the image 106 in the thumbnail 106 is described later.

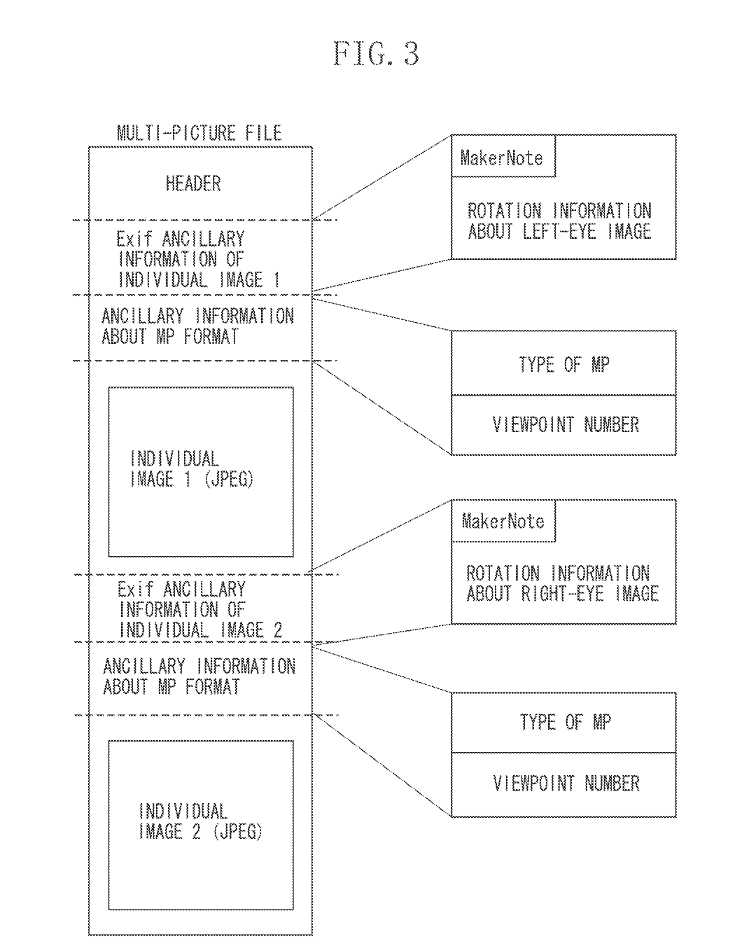

FIG. 3 illustrates a data structure the multi-picture file including 3D image data discussed in the present exemplary embodiment. The data structure in FIG. 3 is described in detail below.

A header is included in the head of the multi-picture file and then information about an individual image 1 is put next into the multi-picture file. Exif information of the individual image 1, ancillary information about a multi-picture (MP) format, and image data of the individual image 1 are put thereinto in this order.

Subsequently, information related to an individual image 2 such as Exif information of the individual image 2, ancillary information about the MP format, and image data of the individual image 2 are put thereinto in this order.

In the present exemplary embodiment, a left-eye image is included in the individual image 1 of the multi-picture file. A right-eye image is included in the individual image 2 of the multi-picture file. Thus, the multi-picture file into which images with parallax are put is generated to generate a stereoscopic (3D) multi-picture file.

A left-eye rotation information is included in a MakerNote of the Exif information of the individual image 1. A rotation angle is included in the rotation information. The type of MP and a viewpoint number are put into the ancillary information about the MP format of the individual image 1. The type of MP includes stereoscopy and multi-view.

A right-eye rotation information is included in a MakerNote of the Exif information of the individual image 2. A rotation angle is included in the rotation information. The type of MP and a viewpoint number are put into the ancillary information about the MP format of the individual image 2. In the present exemplary embodiment, the same rotation angle is included in the left- and the right-eye rotation information.

An MP status is defined to distinguish whether the image of the multi-picture file is the 3D image, the 2D image in which the 3D image is rotated, or other images. Status indicating whether the image of the multi-picture file is the “3D image”, the “2D image in which the 3D image is rotated”, or “other images” is set to the MP status.

Acquiring the MP status allows the display of an icon indicating the 3D image, the 2D image in which the 3D image is rotated, or other images on the thumbnail image. Acquiring the MP status can also be used to determine whether an image is 3D displayed or 2D displayed.

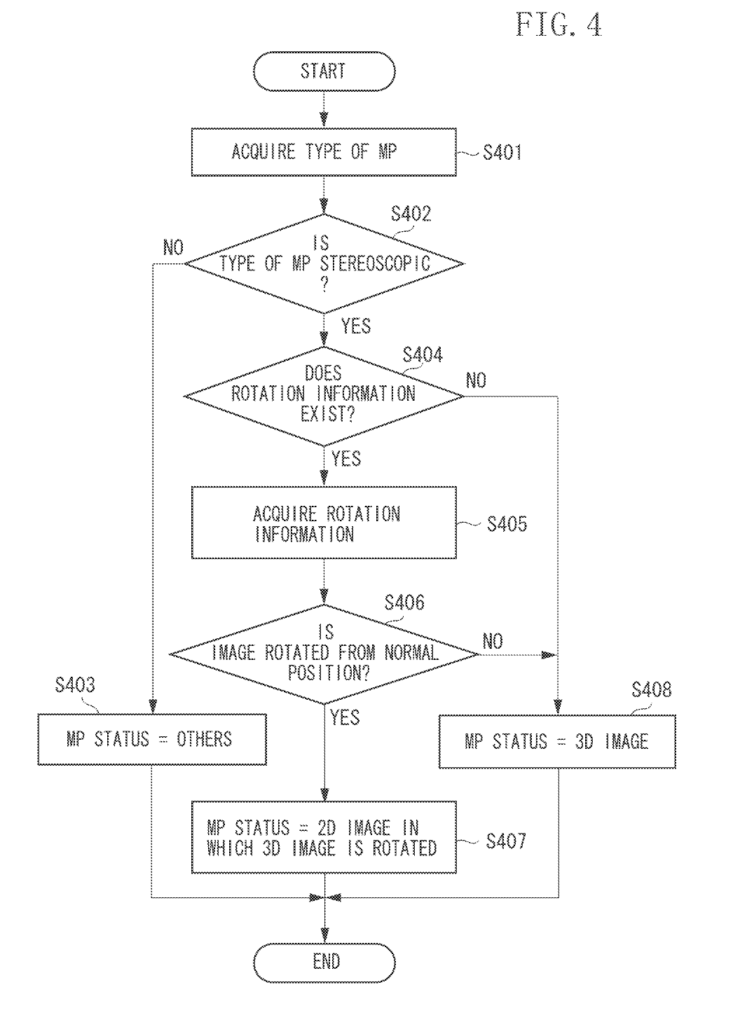

Processing for setting the MP status is described below with reference to a flow chart in FIG. 4.

In step S401, the control unit 201 acquires the type of MP. Acquiring the type of MP allows acquiring whether data at the time of generating the multi-picture file is stereoscopic data.

In step S402, the control unit 201 determines whether the type of MP acquired in step S401 is stereoscopic. If the type of MP is not stereoscopic (NO in step 402), the processing proceeds to step S403. If the type of MP is stereoscopic (YES in step 402), the processing proceeds to step S404.

In step S403, since the type of MP is not stereoscopic, the control unit 201 sets the MP status to the “others” independent of the 3D image.

In step S404, the control unit 201 determines whether rotation information exists in the left- and the right-eye images. If the rotation information exists (YES in step S404), the processing proceeds to step S405. If the rotation information does not exist (NO in step S404), the processing proceeds to step S408.

In step S405, the control unit 201 acquires the rotation information from the left- and the right-eye images. Instep S406, the control unit 201 determines whether the left- and the right-eye images are rotated from the normal position based on the rotation information acquired in step S405. If the control unit 201 determines that the left- and the right-eye images are rotated (YES in step S406), the processing proceeds to step S407. If the control unit 201 determines that the left- and the right-eye images are not rotated (NO in step S406), the processing proceeds to step S408.

In step S407, since the images are rotated from the normal position, the control unit 201 sets the MP status to the “2D image in which the 3D image is rotated”.

In step S408, since the images are not rotated from the normal position, the control unit 201 sets the MP status to the “3D image”. In the present exemplary embodiment, if an image is rotated even a little bit, the image is handled as the 2D image in which the 3D image is rotated. However, such a determination that provides a small tolerance is available.

The above-mentioned processing for setting the MP status is performed to display the icon 102 indicating that an image can be 3D displayed from the MP status and the icon 103 indicating that the 3D image is rotated to display the 2D image in the thumbnail list display in FIG. 1.

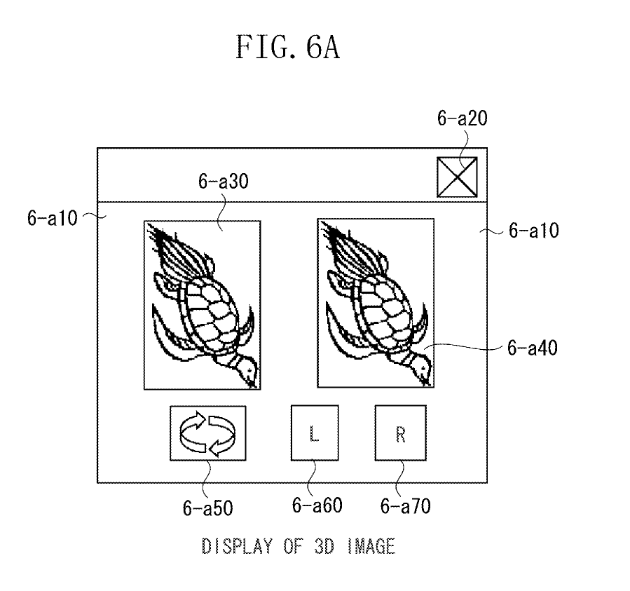

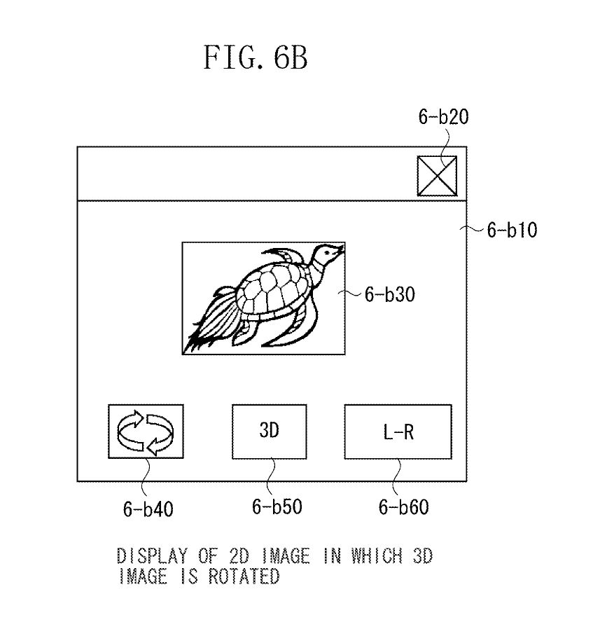

An operator operates the input device 208 for displaying the 3D image 104 in FIG. 1 to display the stereoscopic display screen in FIG. 6A. The operator operates the input device 208 for displaying the 2D image in which the 3D image 105 in FIG. 1 is rotated (hereinafter, referred to as rotation operation) to display the 2D image in which the 3D image is rotated in FIG. 6B.

The above rotation operation performs rotation information update processing for adding or changing rotation information and rotation information storage processing for storing the rotation information. The rotation information refers to information about a rotation flag provided by detecting the rotation angle and the orientation of an image.

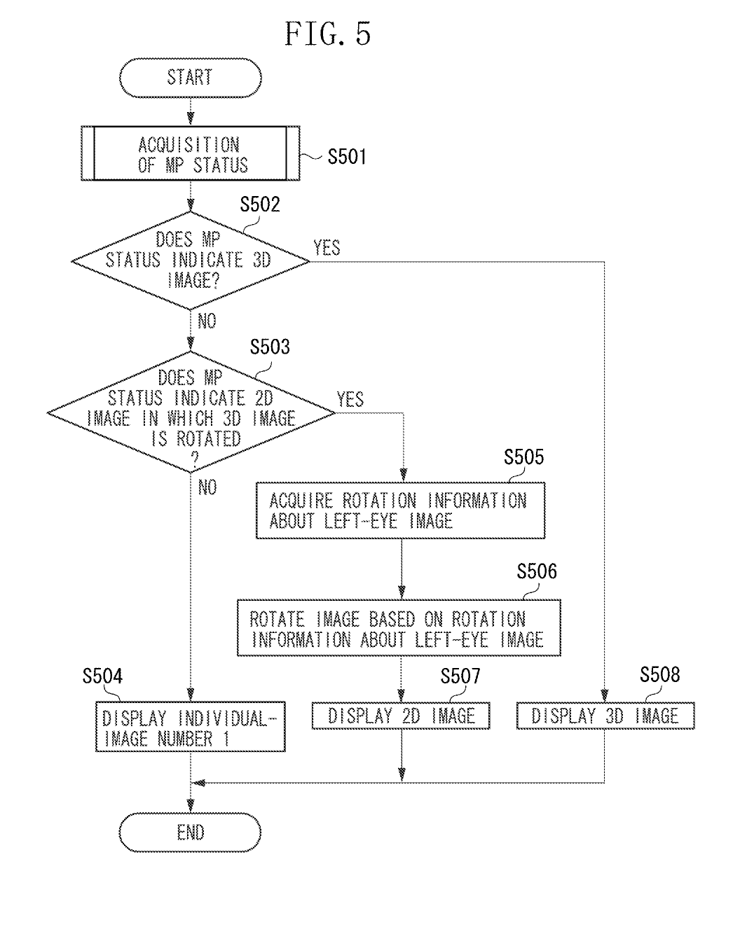

The image display processing for displaying the individual image 1, the 2D image in FIG. 6B, and the stereoscopic display in FIG. 6A based on the MP status set by the processing described in the flow chart in FIG. 4 is described below with reference to a flow chart in FIG. 5.

The individual image 1 is displayed by a general image display method when the MP status indicates “others”.

In step S501, the control unit 201 acquires the MP status. The MP status refers to the value set in the flow chart in FIG. 4.

In step S502, the control unit 201 determines whether the MP status acquired in step S501 indicates the 3D image. If the MP status indicates the 3D image (YES in step S502), the processing proceeds to step S508. If the MP status does not indicate the 3D image (NO in step S502), the processing proceeds to step S503.

In step S503, the control unit 201 determines whether the MP status acquired in step S501 indicates the 2D image in which the 3D image is rotated. If the MP status indicates the 2D image in which the 3D image is rotated (YES in step S503), the processing proceeds to step S505. If the MP status does not indicate the 2D image in which the 3D image is rotated (NO in step S503), the processing proceeds to step S504.

In step S504, the individual image 1 is displayed by a processing step used in a case where the MP status indicates neither the 3D image nor the 2D image in which the 3D image is rotated. The individual image 1 is displayed by a general image display method.

The processing in steps S505 to S507 is performed in a case where the control unit 201 determines that the MP status indicates the 2D image in which the 3D image is rotated, and the left-eye image is displayed as the 2D image by rotating the 3D image.

In step S505, the control unit 201 acquires left-eye rotation information. In step S506, the control unit 201 rotates a left-eye image based on the left-eye rotation information. In step S507, the control unit 201 displays the rotated left-eye image as the 2D image. With this processing, the image in FIG. 6B is displayed.

Step S508 is a processing step in a case where the MP status indicates the 3D image. With this processing, the image in FIG. 6A is displayed as a 3D image.

FIGS. 6A and 6B illustrate screens on which the 3D image and the 2D image in which the 3D image is rotated are displayed in the present exemplary embodiment.

FIGS. 6A and 6B are described below in detail. FIG. 6A is an example illustrating a display of the 3D image. Images and buttons are displayed in an area 6-a10 in FIG. 6A. A button 6-a20 in FIG. 6A is used to close an image which is being displayed. Any of a left- or right-eye image 6-a30 in FIG. 6A is appropriately arranged according to a stereoscopic method (a parallel method or a crossover method). Any of a left- or right-eye image 6-a40 in FIG. 6A is appropriately arranged according to a stereoscopic method (a parallel method or a crossover method).

A rotation button 6-a50 in FIG. 6A starts editing for rotating an image. The operator operates the input device 208 and presses the button 6-a50 to display a dialog to which an angle to be rotated by the control unit 201 is input. The operator operates the input device 208 and inputs any rotation angle to perform the processing in which the control unit 201 rotates the image.

A button 6-a60 in FIG. 6A is used for switching to display only for the left-eye image. The image is displayed by a general display method for displaying one image. A button 6-a70 in FIG. 6A is used for switching to display only for the right-eye image. The image is displayed by a general display method for displaying one image.

FIG. 6B is an example display of the 2D image in which the 3D image is rotated. An area 6-b10 in FIG. 6B is one where images and buttons are displayed. A button 6-b20 in FIG. 6B is used to close an image which is being displayed. An image 6-b30 in FIG. 6B is one in which the 3D image is rotated, so that the image 6-b30 is the 2D image in which the left-eye image is rotated. A rotation button 6-b40 in FIG. 6B is used to start editing for rotating an image.

The operator operates the input device 208 and presses the button 6-b40 to display a dialog to which an angle to be rotated by the control unit 201 is input. The operator operates the input device 208 and inputs any rotation angle to perform the processing in which the control unit 201 rotates the image.

A 3D display button 6-b50 in FIG. 6B is used to return the 2D image to the 3D image which is not yet rotated, and display the 3D image. A button 6-b60 in FIG. 6B is used to display the right-eye image which is not displayed and the left-eye image side by side. Pressing the button 6-b60 allows the display of the other image which is not displayed.

The processing to be performed after the operator operates the input device 208 and inputs any rotation angle by pressing the rotation buttons 6-a50 and 6-b40 and the processing to be performed after the 3D display button 6-b50 in FIG. 6B is pressed will be described below.

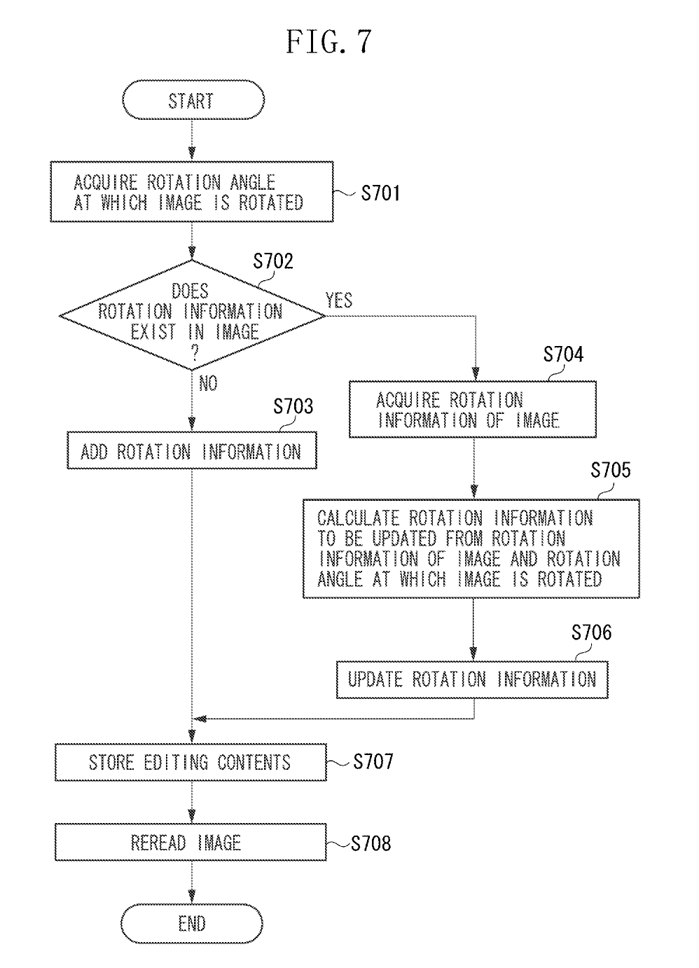

The processing to be performed after the operator operates the input device 208 and inputs any rotation angle by pressing the rotation buttons 6-a50 and 6-b40 is described below with reference to a flow chart in FIG. 7.

In step S701, the control unit 201 acquires the rotation angle input after the operator operates the input device 208 and presses the rotation button 6-a50 in FIG. 6A and the rotation button 6-b40 in FIG. 6B.

Instep S702, the control unit 201 determines whether the rotation information already exists in an image. If the rotation information exists in the image (YES in step S702), the processing proceeds to step S704. If the rotation information does not exist in the image (NO in step S702), the processing proceeds to step S703.

In step S703, the control unit 201 adds the rotation information acquired in step S701 to the image. In step S704, the control unit 201 acquires the rotation information already set to the image.

In step S705, the control unit 201 calculates a rotation angle to which the rotation angle acquired in step S701 is added, based on the rotation information set to the image. In step S706, the control unit 201 performs rotation information update processing using the rotation angle calculated in step S705. In step S707, the control unit 201 performs rotation information storage processing for storing the result of editing the rotation information. In step S708, the control unit 201 rereads the edited image.

As described above, the image is reread to allow the added and updated rotation information to be read from the image. The image is reread and then the processing described in the flowcharts in FIGS. 4 and 5 are performed to determine whether the image is 2D or 3D displayed. If the 3D image is rotated from the normal position, the 2D image is displayed. If the 3D image is not rotated from the normal position, the 3D image is displayed.

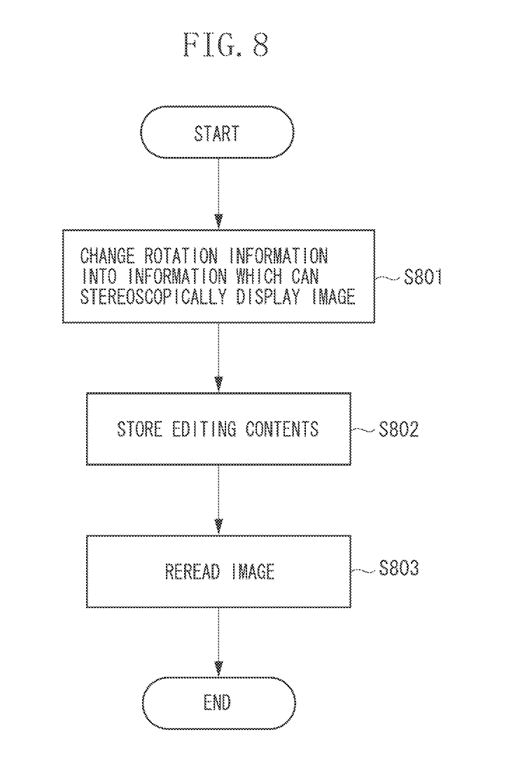

The processing to be performed when the operator operates the input device 208 and presses the 3D display button 6-b50 in FIG. 6B is described below with reference to a flow chart in FIG. 8.

In step S801, the control unit 201 updates the rotation information into information which can stereoscopically display an image. The present exemplary embodiment discusses a state where the rotation information does not exist or a stereoscopic (3D) image at a rotation angle of 0°, so that the rotation information is deleted or 0° is set to the rotation information.

In step S802, the control unit 201 performs processing for storing the result of editing the rotation information. In step S803, the control unit 201 rereads the edited image. The control unit 201 rereads the image and performs the processing described in the flow chart in FIGS. 4 and 5 to display 3D image.

If the 3D image subjected to rotation editing is mixed with other images by the above processing, a) the 3D image can be 3D displayed, b) the 2D image in which the 3D image is rotated can be 2D displayed, and c) the 2D image in which the 3D image is rotated is returned to the 3D image and the 3D image is displayed. In the present exemplary embodiment, the rotation processing of an image rotates both of the left- and right-eye images, however, it may rotate any one of the images.

In the present exemplary embodiment, a rotation angle is set into MakerNote in Exif as rotation information. If the rotation angle is limited in units of 90°, the orientation of Exif of the left- and right-eye images may be used for implementation instead of the left- and right-eye rotation information.

In the present exemplary embodiment, the rotation information is used, however, if it is premised that the whole rotation processing is realized by entity rotation, not only the update of the left- and right-eye rotation information, but also the entity rotation of the left- and right-eye images are performed when an image is rotated. Returning the 2D image to the original 3D image can be realized in such a manner that an rotation angle for returning the 2D image to the original 3D image is calculated from the left- and right-eye rotation information, and the entity rotation of the left- and right-eye images is performed.

In the present exemplary embodiment, the rotation information of an image is added to the left- and right-eye images and updated, however, the rotation information may be added to any one of the images. In the present exemplary embodiment, only the left-eye image is used to display the 2D image, however, only the right-eye image may be used or both the left- and right-eye images may be displayed.

In the present exemplary embodiment, the description is given by using the multi-picture format capable of handling a plurality of image as one file, however, a file including relation information related to the combination of files capable of stereoscopically viewing an image may be used. The relation may be made obvious from a file name instead of the relation information.

In the first exemplary embodiment, an example is described in which the multi-picture file captured by the camera capable of capturing the 3D image at one time is rotated to display the 2D image, and then the 2D image is returned to the original 3D image. The method in which images are arranged side by side to make the images stereoscopic is used in the first exemplary embodiment, so that the images are handled as the ones that cannot be stereoscopically viewed when even a slight rotation of the image is performed.

On the other hand, in a second exemplary embodiment, there is described a 3D image display apparatus in which two images with parallax are stereoscopically displayed on the display 209 in FIG. 2.

Since the rotation editing is performed on the display 209 capable of stereoscopically displaying an image, the operator can easily determine whether an image can be stereoscopically displayed depending on an angle at which the image is rotated based on the display on the display 209.

A 3D display flag indicating whether to perform the 3D display is provided to enable the 3D display even if a rotation angle is small. Arbitrarily setting the 3D display flag allows switching between images which can or cannot be stereoscopically displayed.

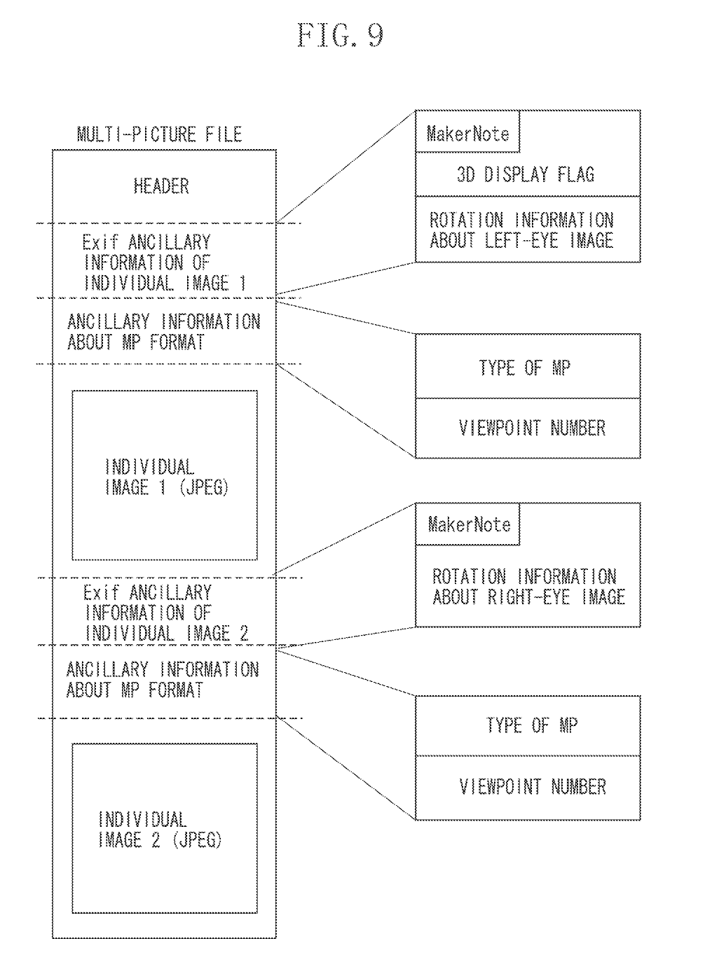

FIG. 9 illustrates a data structure of a multi-picture file including 3D image data to be described in the present exemplary embodiment.

The structure is the one in that a 3D display flag is added to MakerNote of Exif ancillary information of the individual image 1 in the data structure illustrated in FIG. 3. Other than the 3D display flag, the components in FIG. 9 are similar to those in FIG. 3.

The 3D image display program in the present exemplary embodiment is started to display a screen illustrated in FIG. 1 on the display 209 in FIG. 2. FIG. 1 illustrates the display of the thumbnails of images stored in the external storage device 204 in FIG. 2.

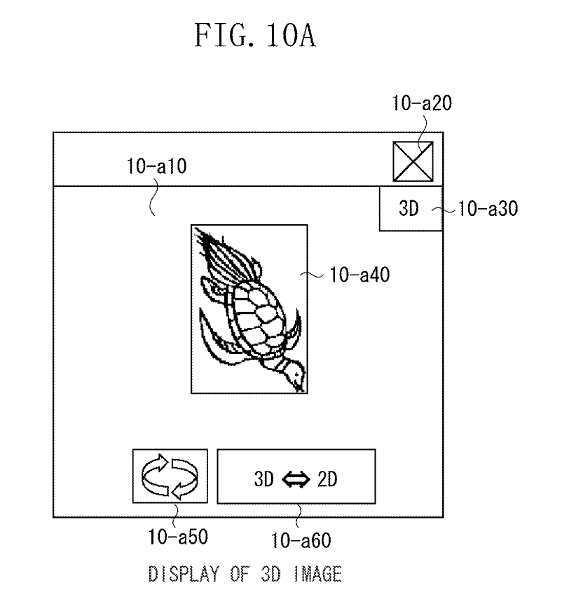

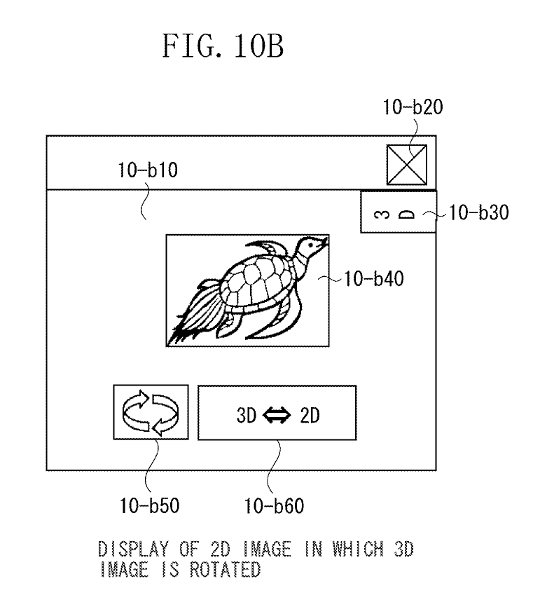

An operator operates the input device 208 and performs the operation for displaying the 3D image 104 in FIG. 1 to display the stereoscopic display screen in FIG. 10A.

The operator operates the input device 208 and performs the operation for displaying the 2D image in which the 3D image 105 in FIG. 1 is rotated to display the 2D image in which the 3D image is rotated in FIG. 10B.

A stereoscopic display screen in FIG. 10A and the screen of the 2D image in which the 3D image is rotated in FIG. 10B, will be described below. FIG. 10A is an example stereoscopic display on the display 209 on which the 3D image can be stereoscopically displayed. Two images with parallax are stereoscopically displayed as one 3D image on the display 209.

An area 10-a10 in FIG. 10A is one where an image and buttons are displayed. A button 10-a20 in FIG. 10A is used to close an image which is being displayed. A 3D icon 10-a30 indicates that an image is displayed as the 3D image.

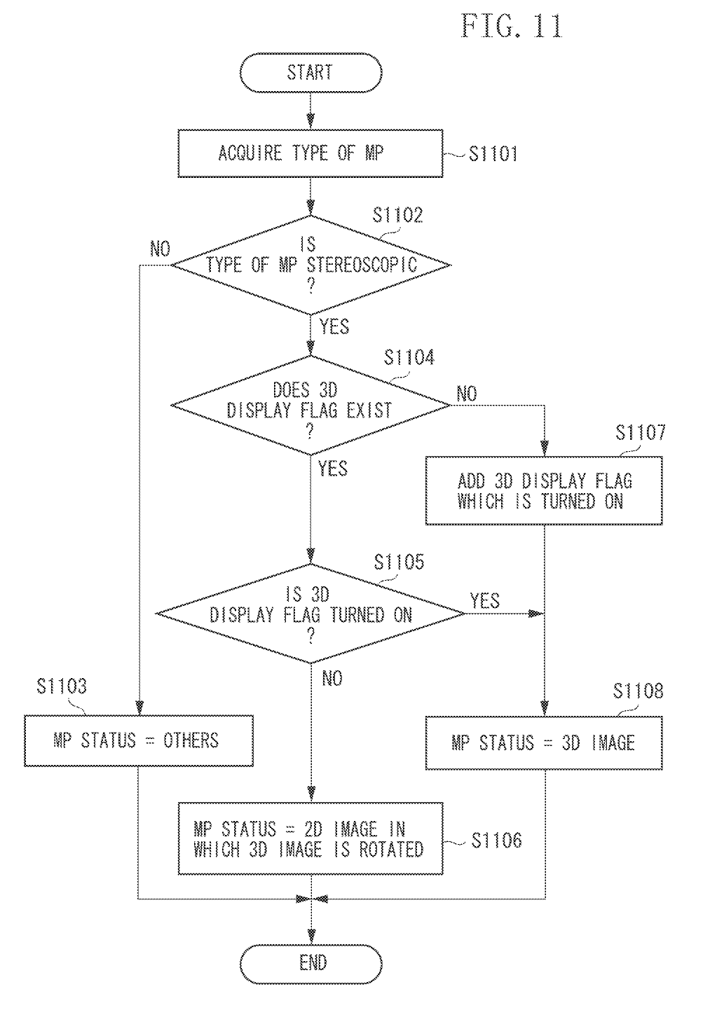

The displayed icon is changed by the MP status set in a flowchart in FIG. 11. Herein, it is determined that the MP status of the displayed image indicates the 3D image to display the 3D icon. The flow chart in FIG. 11 is described in detail below.

A 3D image 10-a40 is generated by two images with parallax. A rotation button 10-a50 is used to start editing for rotating an image. The rotation button 10-a50 is similar in operation to the rotation button 6-a50 in FIG. 6A. The rotation processing is performed according to the flow chart in FIG. 8. A 3D-2D switching button 10-a60 is used to perform switching between a 3D image display and a 2D image display.

FIG. 10B is an example display of the 2D image in which the 3D image is rotated. An area 10-b10 in FIG. 10B is one where an image and buttons are displayed. A button 10-b20 is used to close an image which is being displayed. An icon 10-b30 indicates that the 2D image is displayed by rotating the 3D image.

The displayed icon is changed by the MP status acquired in the flow chart in FIG. 11. Herein, it is determined that the MP status of the displayed image indicates the 2D image in which the 3D image is rotated to display the icon indicating the 2D image in which the 3D image is rotated. The flow chart in FIG. 11 is described in detail below.

An image 10-b40 is displayed as the 2D image in which the 3D image is rotated. A rotation button 10-b50 is used to start editing for rotating an image. The rotation button 10-b50 is similar in operation to the rotation button 6-a50 in FIG. 6A. The rotation processing is performed by procedures illustrated in the flow chart in FIG. 8. A 3D-2D switching button 10-b60 is used to perform switching between a 3D image display and 2D image display.

Processing for acquiring the MP status is described below with reference to a flow chart in FIG. 11. The icon 102 indicates that the image in FIG. 1 can be three dimensionally displayed. The icon 103 indicates that the 3D image is two-dimensionally displayed by the rotation processing. There is described the processing for acquiring the MP status for determining the display of the 3D icon 10-a30 indicating that an image is displayed as the 3D image in FIG. 10A and the icon 10-b30 indicates that the 2D image is displayed by rotating the 3D image.

In step S1101, the control unit 201 acquires the type of MP. Acquiring the type of MP allows acquiring whether data at the time of generating the multi-picture file are stereoscopic. In step S1102, the control unit 201 determines whether the type of MP acquired in step S1101 is stereoscopic. If the type of MP is not stereoscopic (NO in step S1102), the proceeding proceeds to step S1103. If the type of MP is stereoscopic (YES in step S1102), the proceeding proceeds to step S1104.

In step S1103, since the type of MP is not stereoscopic, the control unit 201 sets the MP status to the “others” independent of the 3D image.

In step S1104, the control unit 201 determines whether the 3D display flag exists. If the 3D display flag exists (YES in step S1104), the proceeding proceeds to step S1105. If the 3D display flag does not exist (NO in step S1104), the proceeding proceeds to step S1107.

In step S1105, the control unit 201 determines whether the 3D display flag is turned on. If the 3D display flag is turned on (YES in step S1105), the proceeding proceeds to step S1108. If the 3D display flag is not turned on (NO in step S1105), the proceeding proceeds to step S1106.

In step S1106, since the 3D display flag is turned off, the control unit 201 sets the MP status to the “2D image in which the 3D image is rotated”.

In step S1107, since the 3D display flag does not exists, the control unit 201 adds the 3D display flag which is turned on. In step S1108, since the 3D display flag is turned on, the control unit 201 sets the MP status to the “3D image”.

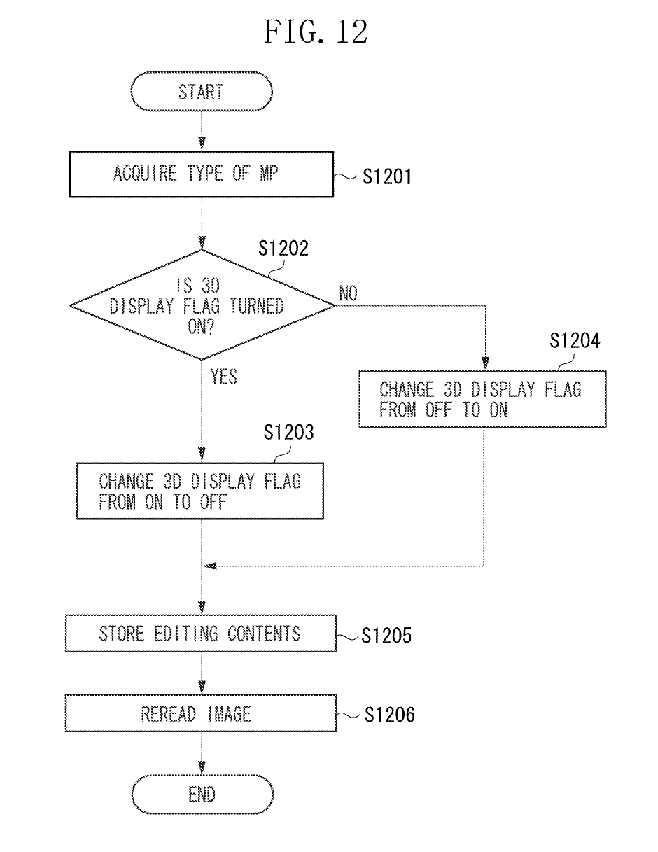

A flow chart in FIG. 12 illustrates processing for switching the 3D display flag by pressing the 3D-2D switching button 10-a60 in FIG. 10A and the 3D-2D switching button 10-b60 in FIG. 10B.

The flow chart in FIG. 12 is described in detail below. In step S1201, the control unit 201 acquires the present 3D display flag.

In step S1202, the control unit 201 determines whether the 3D display flag is turned on. If the 3D display flag is turned on (YES in step S1202), the proceeding proceeds to step S1203. If the 3D display flag is not turned on (NO in step S1202), the proceeding proceeds to step S1204.

In step S1203, the control unit 201 changes the state of the 3D display flag from on to off. Turning the 3D display flag off when the 3D image is rotated handles an image as the 2D display image. In step S1204, the control unit 201 changes the state of the 3D display flag from off to on. Turning the 3D display flag on handles an image as the 3D display image.

In step S1205, the control unit 201 stores editing contents of the 3D display flag. In step S1206, the control unit 201 rereads the edited image. The image is reread to allow the changed 3D display flag to be read from the image.

After the image is read, it is determined whether to display the 2D image in which the 3D image is rotated or the 3D image from the MP status determined by the processing of the flow chart in FIG. 11.

The processing described referring to the flow chart in FIG. 5 is executed and the display in FIG. 10B is performed by the processing of step S507 in FIG. 5. The display in FIG. 10A is performed by the processing of step S508 in FIG. 5.

If the 3D image subjected to rotation editing is mixed with other images by the above processing, it can be switched between whether a) the 3D image is stereoscopically displayed or b) the 3D image is stereoscopically displayed depending on the rotation angle of the 3D image.

Preparing the 3D display flag allows an image to be displayed as the 3D image with rotation tolerated to some degree if the 3D image is rotated.

In the present exemplary embodiment, the operator can switch the 3D display flag indicating whether to perform the 3D display. However, the 3D display flag may be switched according to a rotation angle on a program.

In the first exemplary embodiment, an example is described in which the multi-picture file captured by the camera capable of capturing the 3D image at one time is rotated to perform display. In a third exemplary embodiment, two images with parallax, which are captured twice, and one multi-picture file is generated therefrom. The images are captured twice in a portrait mode.

The following rotation information is added to each of the images. It is assumed that capturing is performed at a rotation angle of 90° in left-eye rotation information as a left-eye image, and at a rotation angle of 270° in right-eye rotation information as a right-eye image. In the present exemplary embodiment, the left- and the right-eye images are captured in a portrait mode, however, it is assumed that the rotation angles are different depending on difference in posture.

Since different rotation angles are set to the left- and the right-eye images, if the images are rotated, the images cannot be returned to the normal position. For this reason, rotation information in capturing a left-eye image and rotation information in capturing a right-eye image are added to MakerNote of Exif of the left- and the right-eye images, respectively.

Angles capable of making the normal position in capturing the 3D image are set to the rotation information in capturing a left-eye image and the rotation information in capturing a right-eye image. In the present exemplary embodiment, 90° is set to the rotation information in capturing a left-eye image and 270° is set to the rotation information in capturing a right-eye image.

In the present exemplary embodiment, the rotation processing of an image is performed by rotating both of the left- and the right-eye images.

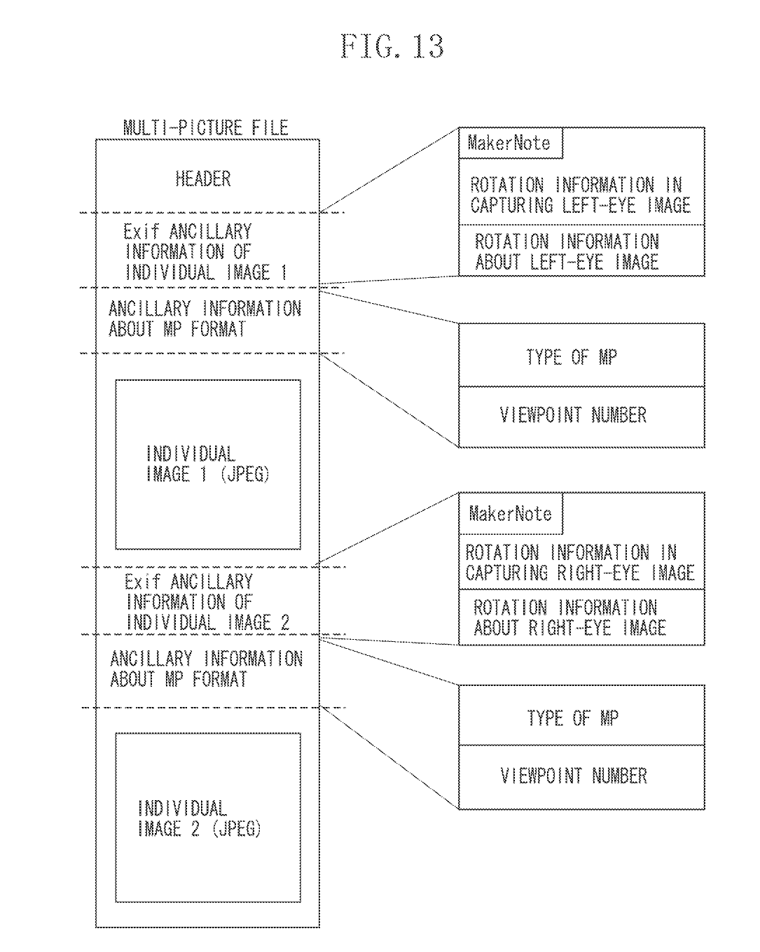

FIG. 13 illustrates a data structure of a multi-picture file including 3D image data discussed in the present exemplary embodiment. The rotation information in capturing a left-eye image and the rotation information in capturing a right-eye image are added to MakerNote of Exif information ancillary-information of individual image 1 and MakerNote of Exif information ancillary-information of individual image 2 respectively in the structure of data in FIG. 3. Other than the rotation information in capturing a left-eye image and the rotation information in capturing a right-eye image, the items and components in FIG. 13 are similar to those in FIG. 3.

The 3D image display program in the present exemplary embodiment is started to display the screen in FIG. 1 on the display 209 in FIG. 2. FIG. 1 illustrates the display of the thumbnails of images stored in the external storage device 204 in FIG. 2.

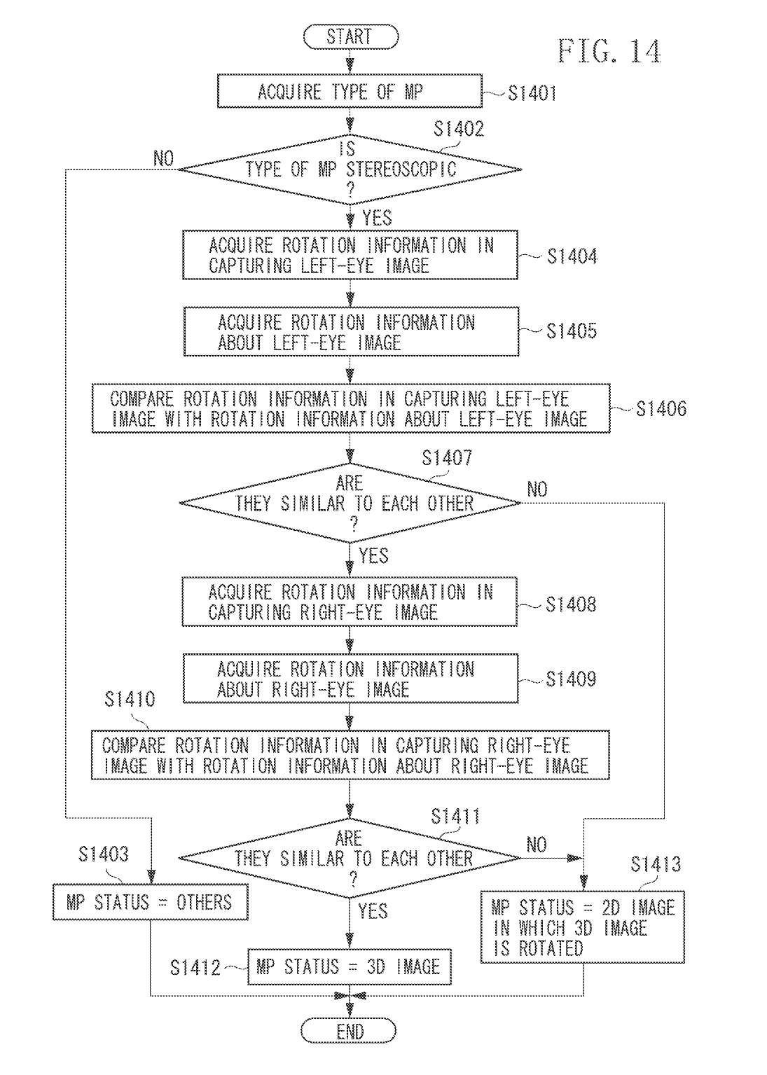

The operator operates the input device 208 and performs the operation for displaying the 3D image 104 in FIG. 1 to display the stereoscopic display screen in FIG. 6A. The operator operates the input device 208 and performs the operation for displaying the 2D image in which the 3D image 105 in FIG. 1 is rotated to display the 2D image in which the 3D image is rotated in FIG. 6B. Processing for acquiring the MP status determining any of the screen of the stereoscopic image display in FIG. 6A and the screen of the 2D image in which the 3D image is rotated in FIG. 6B is described below with reference to a flow chart in FIG. 14.

The flow chart in FIG. 14 illustrates a procedure for acquiring the MP status. The processing described referring to the flow chart in FIG. 5 is executed using the acquired MP status. That processing determines to display which of the icon 102 indicating that the image in FIG. 1 can be 3D displayed, the icon 103 indicating that the 3D image in FIG. 1 is 2D displayed by rotation processing, the stereoscopic image in FIG. 6A, or the 2D image in which the 3D image is rotated in FIG. 6B.

The processing performed according to a flow chart in FIG. 14 is described in detail below. In step S1401, the control unit 201 acquires the type of MP. Acquiring the type of MP allows acquiring whether data at the time of generating the multi-picture file are stereoscopic.

In step S1402, the control unit 201 determines whether the type of MP acquired in step S1401 is stereoscopic. If the type of MP is not stereoscopic (NO in step 1402), the processing proceeds to step S1403. If the type of MP is stereoscopic (YES in step 1402), the processing proceeds to step S1404.

In step S1403, since the type of MP is not stereoscopic, the control unit 201 sets the MP status to the “others” independent of the 3D image. In step S1404, the control unit 201 acquires rotation information in capturing a left-eye image from the left-eye image.

In step S1405, the control unit 201 acquires rotation information about a left-eye image from the left-eye image. In step S1406, the control unit 201 compares the rotation information in capturing the left-eye image with the rotation information about the left-eye image acquired in steps S1404 and S1405, respectively.

In step S1407, the control unit 201 determines whether comparison results of the rotation information performed in step S1406 are similar to each other. If the control unit 201 determines that they are similar (YES in step S1407), the processing proceeds to step S1408. If the control unit 201 determines that they are not similar (NO in step S1407), the processing proceeds to step S1413.

In step S1408, the control unit 201 acquires rotation information in capturing a right-eye image from the right-eye image. In step S1409, the control unit 201 acquires rotation information about the right-eye image from the right-eye image. In step S1410, the control unit 201 compares the rotation information in capturing the right-eye image with the rotation information about the right-eye image acquired in steps S1408 and S1409, respectively.

In step S1411, the control unit 201 determines whether the comparison results of the rotation information performed in step S1410 are similar to each other. If the control unit 201 determines that they are similar (YES in step S1411), the processing proceeds to step S1412. If the control unit 201 determines that they are not similar (NO in step S1411), the processing proceeds to step S1413.

In step S1412, since the images are not rotated from the normal position, the control unit 201 sets the MP status to the “3D image”. In step S1413, since the images are rotated from the normal position, the control unit 201 sets the MP status to the “2D image in which the 3D image is rotated”.

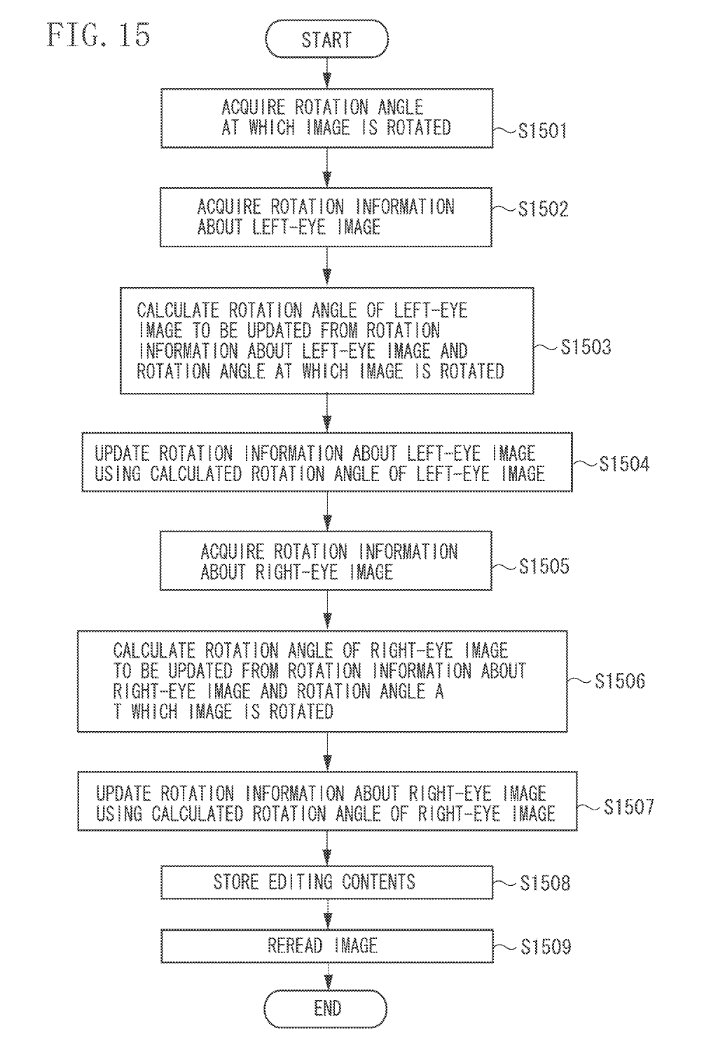

Processing for rotating an image is described below with reference to a flow chart in FIG. 15.

In step S1501, the operator presses the rotation button 6-a50 in FIG. 6A and the rotation button 6-b40 in FIG. 6B, and then the control unit 201 acquires the input rotation angle. In step S1502, the control unit 201 acquires rotation information about the left-eye image.

In step S1503, the control unit 201 calculates a rotation angle from the rotation information about the left-eye image acquired in step S1502 if the rotation angle acquired instep S1501 is rotated. In step S1504, the control unit 201 updates the rotation information about the left-eye image using the rotation angle of the left-eye image calculated in step S1503. In step S1505, the control unit 201 acquires the rotation information about the right-eye image.

In step S1506, the control unit 201 calculates a rotation angle from the rotation information about the right-eye image acquired in step S1505 if the rotation angle acquired instep S1501 is rotated. In step S1507, the control unit 201 updates the rotation information about the right-eye image using the rotation angle calculated in step S1506. In step S1508, the control unit 201 stores the updated rotation information about the left- and right-eye images.

In step S1509, the control unit 201 rereads the edited image. The image is reread to enable the added or updated rotation information to be read from the image. After the image is read, the processing of the flow charts in FIGS. 5 and 14 is performed to determine whether the image is 2D displayed or 3D displayed. If the 3D image is rotated from the normal position, the 2D image is displayed. If the 3D image is not rotated from the normal position, the 3D image is displayed.

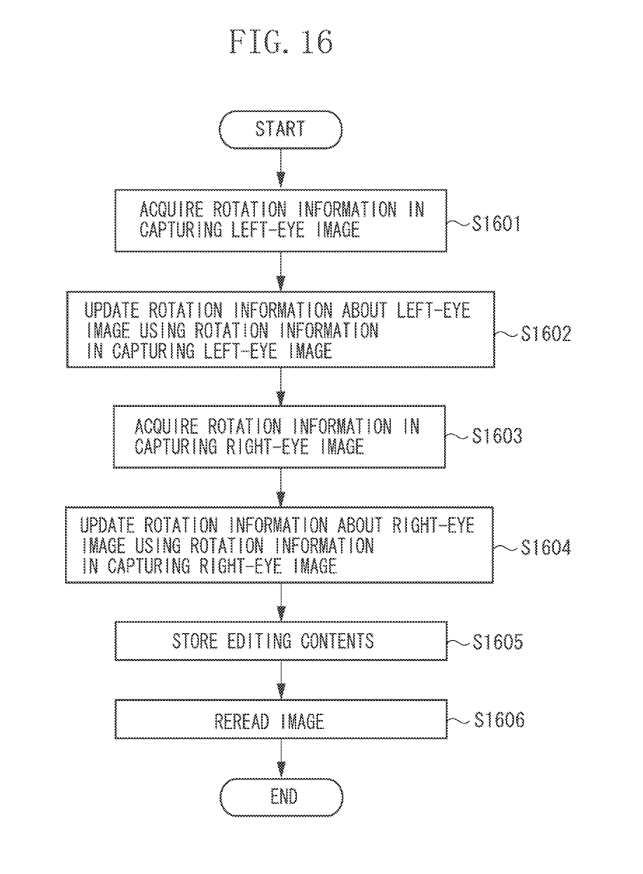

The operator operates the input device 208 and presses the 3D display button 6-b50 in FIG. 6B to allow the image to be returned to the 3D image. Processing for returning the rotated image to the original 3D image is described below with respect to a flow chart in FIG. 16. The processing is performed to place the left- and right-eye images to the normal position.

In step S1601, the control unit 201 acquires the rotation information in capturing the left-eye image. In step S1602, the control unit 201 updates the rotation information about the left-eye image using the rotation information in capturing the left-eye image to rewrite the rotation information about the left-eye image. In step S1603, the control unit 201 acquires the rotation information in capturing the right-eye image. In step S1604, the control unit 201 updates the rotation information about the right-eye image using the rotation information in capturing the right-eye image to rewrite the rotation information about the right-eye image.

In step S1605, the control unit 201 stores the updated rotation information about the left- and right-eye images and edited contents. In step S1606, the control unit 201 rereads the edited image. The image is reread to allow the updated rotation information to be read from the image.

For the updated rotation information, the rotation information in capturing the left-eye image is made similar in values to the rotation information about the left-eye image by the processing in steps S1601 to S1605. The rotation information in capturing the right-eye image is also made similar in values to the rotation information about the right-eye image. After the image is reread, the processing of the flowcharts in FIGS. 5 and 14 is performed to determine that the image is 3D displayed.

In a case where the 3D image subjected to rotation editing by the above processing using the 3D image whose left- and right-eye images are different in rotation angle in capturing the 3D image is mixed with other images by the above processing, the following display can be performed. That is, a) the 3D image can be 3D displayed, b) the 2D image in which the 3D image is rotated can be 2D displayed, and c) the 2D image in which the 3D image is rotated is returned to the 3D image and the 3D image is displayed.

In the present exemplary embodiment, an example is described in which the rotation information in capturing the left-eye image is different from the rotation information in capturing the right-eye image. However, if the rotation information in capturing the left-eye image is similar in value to the rotation information in capturing the right-eye image, any one of them may be input into MakerNote of the individual image 1 or the individual image 2.

Similarly to the first exemplary embodiment, if the rotation angle is limited in units of 90°, the orientation of Exif of the left- and right-eye images may be used for implementation instead of the left- and right-eye rotation information. Further, in the rotation processing of an image, both of the left- and right-eye images are rotated, however, any one of the images may be rotated.

Similar to the first exemplary embodiment, if it is premised that the whole rotation processing is realized by entity rotation, not only the update of the left- and right-eye rotation information, but also the entity rotation of the left- and right-eye images may be performed when an image is rotated.

Aspects of the present invention can also be realized by a computer of a system or apparatus (or devices such as a CPU, a micro processing unit (MPU), and/or the like) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-088461 filed Apr. 12, 2011, which is hereby incorporated by reference herein in its entirety.

What is claimed is:

1. An image display apparatus for displaying an image by performing image processing corresponding to rotation information, the image display apparatus comprising:
a presence/absence determining unit configured to determine whether rotation information exists;
a state determination unit configured to determine whether an image is rotated from a state of an angle at which stereoscopic display is performed if the rotation information exists;
a display unit configured to perform a stereoscopic display on a display area using a plurality of images if the image is not rotated and display any one of the plurality of images if the image is rotated; and
a control unit configured to control operation of each unit.

2. The image display apparatus according to claim 1, wherein the rotation information is information about a rotation angle or rotation flag of an image and information added or changed by an operator performing rotation operation.

3. The image display apparatus according to claim 2, wherein the rotation operation includes rotation information update processing for adding or changing the rotation information and rotation information storage processing for storing the rotation information.

4. The image display apparatus according to claim 3, wherein the rotation information update processing is rewriting the rotation information by the acquired rotation information.

5. The image display apparatus according to claim 3, wherein the rotation information storage processing is an operation that stores an image using rewritten rotation information.

6. The image display apparatus according to claim 3, wherein the rotation information storage processing is an operation that performs an entity rotation of an image using rewritten rotation information and stores the image.

7. An image display method for displaying an image by performing image processing corresponding to rotation information, the method comprising:
determining whether rotation information exists;
determining whether an image is rotated from a state of an angle at which stereoscopic display is performed if the rotation information exists;
performing a stereoscopic display on a display area using a plurality of images if the image is not rotated, and displaying any one of the plurality of images if the image is rotated; and
controlling operation of each unit.

8. A non-transitory computer readable storage medium storing a program causing a computer to execute each step of an image display method for displaying an image by performing image processing corresponding to rotation information, the method comprising:
determining whether rotation information exists;
determining whether an image is rotated from a state of an angle at which stereoscopic display is performed if the rotation information exists;
performing a stereoscopic display on a display area using a plurality of images if the image is not rotated, and displaying any one of the plurality of images if the image is rotated.
